(19) United States
(12) Patent Application Publication
(10) Pub. No.: US 2006/0097510 A1
(43) Pub. Date: May 11, 2006

(54) Paper clip with index tab

(76) Inventor: Melanie A. Sharpe, Dolton, IL (US)

Correspondence Address: Richard C. Litman;LITMAN LAW OFFICES, LTD., P.O. Box 15035, Arlington, VA, 22215, US

(21) Appl. No.: 10/981,794

(22) Filed: Nov. 5, 2004

(51) Int. Cl. B42F 21/00

(52) U.S. Cl. 283/36

(57) ABSTRACT

A series of embodiments of a paper clip with index tab enables a relatively large clip to perform double duty as a sheet fastener and also for holding an index tab to the edge(s) of the sheet(s). The clip includes a relatively long, straight medial spine disposed parallel and adjacent to the edge(s) of the sheet(s) when the clip is secured thereto. An index tab is secured around the spine and extends outwardly away from the sheet(s) to make visible any data thereon. The tab may be opaque and may contain the index data upon the face thereof, or may be a transparent or translucent hollow sleeve with removable index tag installed therein.

### BACKGROUND OF THE INVENTION

1. Field of the Invention

The present invention relates to temporarily attachable and removable clips and other fasteners for sheet material. More specifically, the present invention relates to a paper clip with an integral index tab.

2. DESCRIPTION OF THE RELATED ART

The general concept of placing some form of index or identification tab or label upon a sheet material fastener has been known for some time. Various such devices include binder clips and paper clips having tabs permanently or removably secured thereto. Most, if not all, such devices either (1) conceal the index tab below the edge of the sheets so that it cannot be seen when placed upon any but the front sheet in a series of papers; or (2) where the tab extends beyond the edges of the sheets, it does not allow the fastener to completely grip the sheets.

An example of such a clip is shown in German Patent Publication No. 3,322,757, published on Jan. 3, 1985, titled in English as “Tab for index cards, files or the like.” The device uses a clip that passes through an information-carrying strip having upper and lower slots therein for the clip. The strip may be written upon and the assembly clipped to the edge(s) of the file(s) as appropriate. The strip is discarded when no longer needed. Much of the area of the strip is wasted, as it is concealed between sheets of material when attached thereto.

Another device is shown in International Patent No. WO 95/19023 published on Jul. 13, 1995, having the English title “Label Support Adaptable To Any Paper Clip System.” This device comprises a relatively complex, three leaved sheet that forms a pocket into which a clip is inserted. The sheet may be written upon, and the assembly clipped to the edge(s) of document(s) or the like. This configuration conceals most of the tag between document sheets; most of it is not visible unless displayed on the front sheet.

None of the above inventions and patents, taken either singly or in combination, is seen to describe the instant invention as claimed. Thus, a paper clip with index tab solving the aforementioned problems is desired.

### SUMMARY OF THE INVENTION

The paper clip with index tab enables a relatively large clip to perform double duty as a sheet fastener and also for holding an index tab to the edge(s) of the sheet(s). The clip used with the present device includes a relatively long, straight medial spine disposed parallel and adjacent to the edge(s) of the sheet(s) when the clip is secured thereto. An index tab is secured around the spine and extends outwardly away from the sheet(s) to make visible any data thereon. The tab may be opaque and may contain the index data upon the face thereof, or may be a transparent or translucent hollow sleeve having a removable index tag installed therein.

These and other features of the present invention will become readily apparent upon further review of the following specification and drawings.

### BRIEF DESCRIPTION OF THE DRAWINGS

FIG. 1 is an environmental, perspective view of a paper clip with index tab according to the present invention used on file folders in a filing cabinet.

FIG. 2 is an environmental front elevation view of a series of files, illustrating the placement of a paper clip with index tab of the present invention thereon, showing the index tabs extending visibly beyond the edges of the sheets.

FIG. 3 is an exploded perspective view of one embodiment of the paper clip with index tab of the present invention, showing installation of the index tab upon the clip.

FIG. 4 is an exploded perspective view of another embodiment of a paper clip with index tab according to the present invention, showing installation of a hollow sleeve type tab with removable tag to the clip.

FIG. 5 is a perspective view of yet another embodiment of a paper clip with index tab according to the present invention, wherein the clip is of a different type than the clips of FIGS. 1 through 4.

FIG. 6 is an environmental side elevation view showing details of the attachment of a hollow sleeve type tab to a clip and the securing together of plural sheets by means of the clip.

Similar reference characters denote corresponding features consistently throughout the attached drawings.

### DETAILED DESCRIPTION OF THE PREFERRED EMBODIMENTS

The present invention comprises a series of embodiments of a clip having an index tab attached thereto, and providing for the complete display of the tab beyond the edge of a sheet(s) to which the clip has been attached while still permitting complete seating of the clip against the edge of the sheet(s). Various types of clips may be used to form a part of the present invention. Also, various types of index tabs may be used to form a part of the clip and tab structure, e.g. opaque tabs providing a writing surface or otherwise marked thereon, or tabs having transparent or translucent sleeves for the removable insertion of an index tag therein.

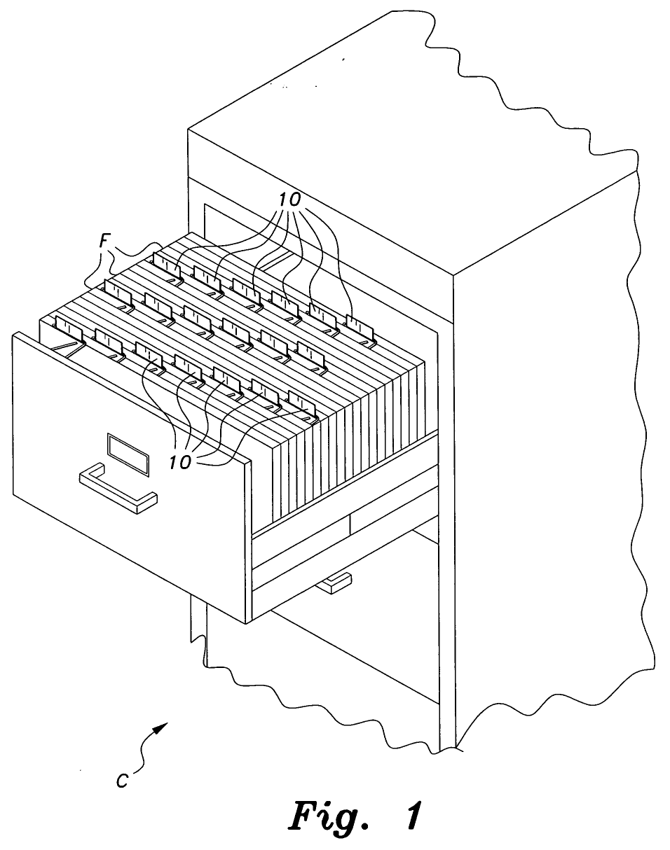

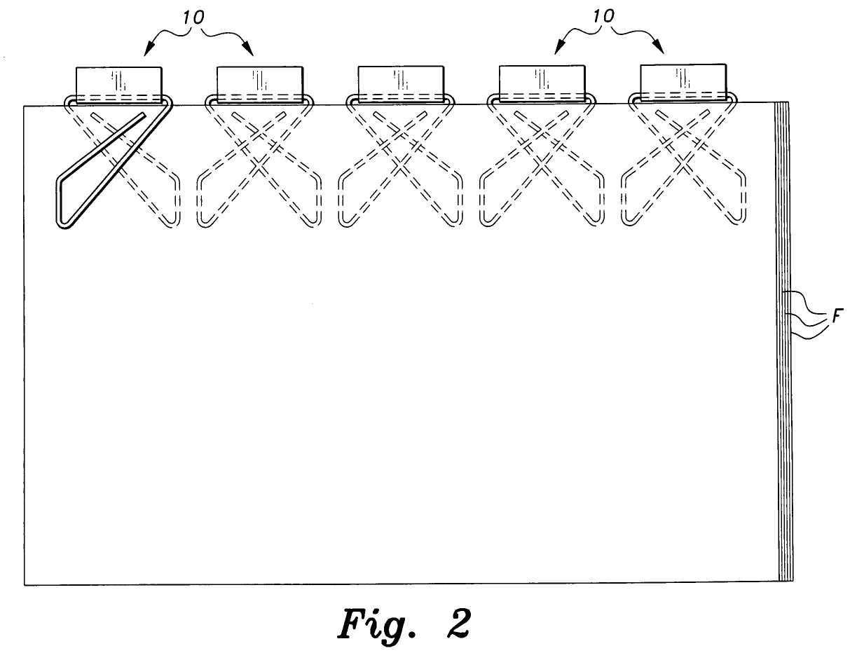

FIG. 1 of the drawings shows a filing cabinet C with a series of files F therein, with each of the files F identified with one of the present clip and tab assemblies 10. FIG. 2 provides a front elevation view of a series of files F superimposed over one another, with a corresponding series of the clip and tab assemblies 10 secured to their respective upper edges E. This arrangement is essentially the same as the arrangement of the files F in the file cabinet C illustrated in FIG. 1 of the drawings.

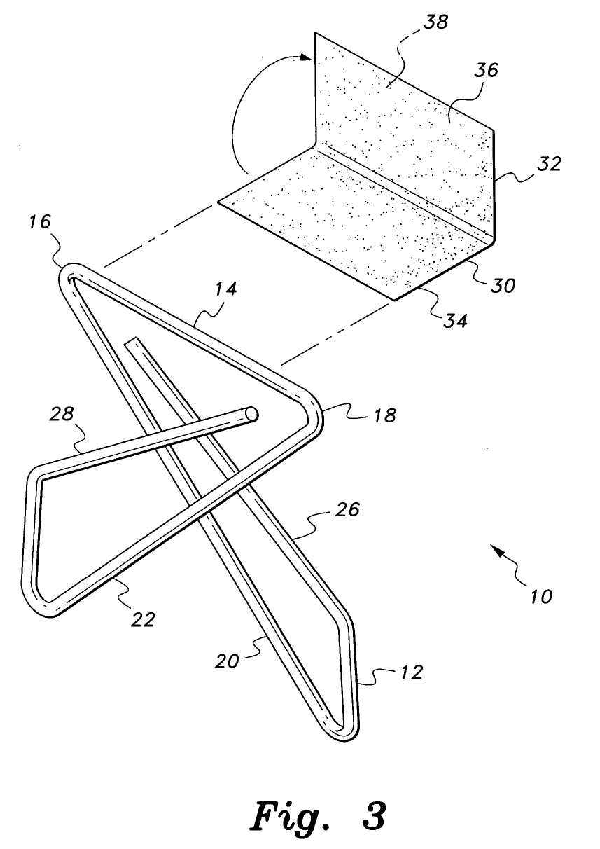

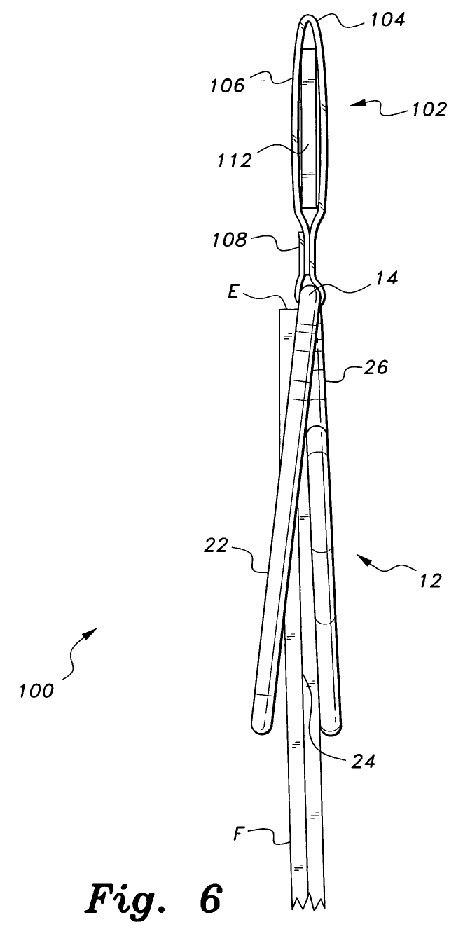

FIG. 3 provides an exploded perspective view of a first clip and index tab embodiment 10. The clip 12 is formed of a springy wire and includes a generally medial, straight spine portion 14 having opposite first and second ends 16 and 18. Each end 16 and 18 has a leg extending generally diagonally therefrom, respectively first leg 20 and second leg 22. The two legs 20 and 22 cross and overlap to define a sheet gripping interstice 24 therebetween (shown in FIG. 6). Each of the two legs 20 and 22 further includes a doubler, respectively 26 and 28, which extends from the distal end of each of the legs and back toward the respective ends 16 and 18 of the spine portion 14. This clip configuration is exemplary, and other configurations having a straight spine portion for attachment of the index tab may be used as well. The clip 12 will be recognized as the type of clip often referred to as the Ideal paper clip, Ideal paper clamp. Butterfly paper clip (or clamp), etc., characterized by the two diagonal overlapping triangles that permit clamping onto thick stacks of paper.

An index tab sheet 30 wraps around the spine 14 of the clip 12 to adhesively secure the sheet 30 permanently to the clip 12. The sheet 30 includes opposite first and second leaves, respectively 32 and 34, which fold together and adhere to one another by means of the adhesively coated first surface 36 of at least one of the leaves 32 and/or 34. The opposite second surface 38 of the sheet 30 provides an opaque recording surface for the notation of various indicia thereon, e.g., letters of the alphabet, numbers, dates, subject headings (either full or abbreviated), docket or case numbers or names, symbols, etc., as desired. The index tab sheets 30 may be formed of any practicable material as desired, e.g., paper, plastic, leather, or even metal, if so desired. A thin stiffener may be inserted between the two leaves 32 and 34 where more flexible materials are used for the tab sheet 30, if so desired. Alternatively, the two leaves 32 and 34 may be secured together by wrapping them with a short length of transparent or translucent adhesive tape, if so desired.

When the tab 30 has been secured to the spine 14 of the clip 12, the two joined leaves 32 and 34 extend essentially opposite the sheet gripping interstice 24 of the clip 12. This results in the tab 30 extending beyond the edge(s) E of the file(s) F or other sheet(s) to which the clip 12 has been secured for ease of viewing of the tab and any information thereon, while allowing the clip 12 to seat completely over the file(s) or sheet(s) with the spine 14 of the clip resting immediately adjacent the edge(s) of the file(s) or sheet(s), a shown clearly in FIG. 2.

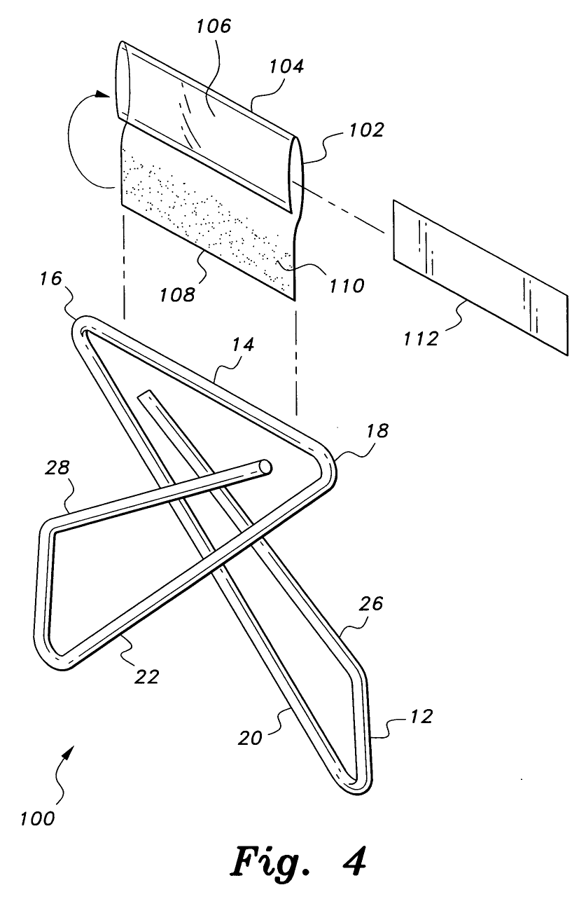

FIG. 4 illustrates another embodiment of the present clip and tab assembly, designated as clip and tab 100. The clip 12 is identical to the clip 12 of FIG. 3, having a spine 14 with opposed first and second ends 16 and 18, first and second legs 20 and 22 extending from the ends 16 and 18 of the spine 14 to cross one another and define an interstice 24 therebetween, and first and second doublers 26 and 28 extending from their respective legs 20 and 22. However, the index tab 102 differs from the index tab 10 of FIG. 3, in that the tab 102 comprises a hollow, flattened tube or sleeve 104 having at least one translucent side 106. The tab 102 also includes a leaf 108 having an adhesively coated surface 110, which wraps about the spine 14 of the clip 12 to adhesively secure the tab 102 thereto. The leaf 108 may also be formed of a transparent or translucent material unitarily with the sleeve 104, and may wrap over the face of the sleeve 104 and secure adhesively thereto to secure the tab 102 permanently in place on the clip 12. Alternatively, the leaf 108 may extend only along the lower edge of the translucent or transparent sleeve 104, remaining clear of the majority of the area of the sleeve 104 and particularly its transparent or translucent viewing surface or side 106, as shown in FIG. 6. Alternatively, transparent or translucent adhesive tape (not shown) may be used to secure the leaf 108 to the sleeve 104, and/or to secure the tab 102 to the spine 14 of the clip 12.

The hollow transparent or translucent sleeve 104 of the tab 102 of FIG. 4 allows the information displayed with the tab 102 to be changed or modified as desired. The information is contained on an indicia recording tag 112, which may be removably installed within the sleeve 104 and viewed through the transparent or translucent side or surface 106 of the tab 102. The tag 112 may be removed and replaced with a new tag as the need arises, e.g. when a case is closed and a new case opened or for any other reason as desired or required.

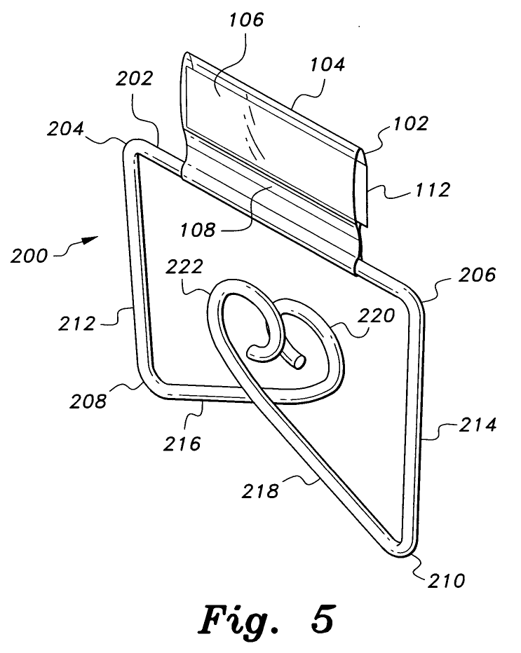

FIG. 5 illustrates a different paper clip embodiment from that disclosed in FIGS. 1 through 4. The clip 200 of FIG. 5 is also formed of a springy wire and includes a straight, generally medial spine 202 having opposed first and second ends 204 and 206. However, the clip 200 of FIG. 5 differs from the clip 100 of FIGS. 1 through 4 and 6, in that the first and second legs 208 and 210 each have a first segment, respectively 212 and 214, extending generally orthogonally from their respective spine ends 204 and 206. A second segment, respectively 216 and 218, extends from the distal end of each first segment 212 and 214, and is angled inwardly toward the opposite leg. Each second segment 216 and 218 terminates in a coil, respectively 220 and 222, with the two coils 220 and 222 overlapping one another to define a sheet gripping interstice therebetween, similar to the interstice 24 shown in FIG. 6.

The tab 102 illustrated with the clip 200 of the FIG. 5 embodiment has essentially the same configuration as the tab 102 illustrated in detail in FIG. 4, having a sleeve 104 with at least one transparent or translucent side or surface 106 and an attachment leaf 108, which wraps about the spine 202 of the clip 200. An index tag 112 or the like is removably installed within the sleeve 104 to identify the file or other sheet(s) to which the clip 200 is attached. While the tab 102 and its tag 112 are shown somewhat narrower than the length of the spine 202 of the clip 200 of FIG. 5, it will be understood that the tab 102 and its tag 112 could have substantially the same width as the length of the spine 202, or could even be somewhat wider with a narrower attachment leaf 108 wrapping about the spine 202 between the two leg first segments 212 and 214. Alternatively, the index tag 30 configuration illustrated in FIG. 3 could be used with the clip 200 embodiment of FIG. 5, if so desired.

FIG. 6 illustrates the operation of the present paper clip and index tab invention, showing a first embodiment clip 12 secured to the upper edge E of a series of file sheets F. A hollow sleeve type tab 102 is adhesively secured to the spine 14 of the clip 12, with the height or span of the sleeve 104 extending substantially opposite the plane of the interstice 24 to position the tab 102 visibly beyond the edge(s) E of the file sheets F. Yet, the spine 14 of the clip 12 is positioned essentially immediately adjacent to and in contact with the spine 14 of the clip 12 (neglecting the thickness of the wrapped leaf 108 of the tab 102), thereby assuring maximal grip for the clip 12 on the file(s) F.

The tabs are quite inexpensive, and may be preprinted with letters of the alphabet (or other characters from non-Roman alphabets), numbers, dates, symbols, codes, colors, etc., as desired to differentiate different files from one another when attached thereto. The tabs themselves may be formed of any practicable material in opaque form, with a clear or translucent plastic being used for the embodiment having a sleeve with removable index tag. The paper clip with index tab may also be provided in kit form, with the user marking and fastening the tabs to the clips as desired.

It is to be understood that the present invention is not limited to the embodiments described above, but encompasses any and all embodiments within the scope of the following claims.

I claim:

1. A paper clip with index tab assembly, comprising:
a clip having an elongated, linear spine and first and second clamping members extending to one side of the spine from opposite ends of the spine, the clamping members defining a sheet gripping interstice therebetween; and
a tab sheet wrapped about and adhesively secured permanently to the spine of the clip, the said tab sheet extending substantially opposite the sheet gripping interstice of the clip so that the tab sheet is visible when the clip is removably secured to an edge a sheet of material with the spine disposed immediately adjacent the edge of the sheet.

2. The paper clip with index tab assembly according to claim 1, wherein said tab sheet is opaque and further includes an indicia recording surface disposed externally upon at least one leaf thereof.

3. The paper clip with index tab assembly according to claim 1, wherein said tab sheet has at least one leaf comprising a hollow, flattened tube having at least one translucent side.

4. The paper clip with index tab assembly according to claim 3, further including an indicia recording tag removably disposed within the hollow tube of said tab sheet and visible through the at least one translucent side thereof when installed therein.

5. The paper clip with index tab assembly according to claim 1, wherein said clip comprises a single wire bent to form the spine and the clamp members.

6. The paper clip with index tab according to claim 1, wherein said clip is an Ideal paper clip.

7. A paper clip with index tab assembly, comprising:
a clip having an elongated, linear spine and first and second clamping members extending to one side of the spine from opposite ends of the spine, the clamping members defining a sheet gripping interstice therebetween;
a tab sheet wrapped about the and adhesively secured permanently to the spine of said clip, the tab sheet comprising an opaque first leaf and an opaque second leaf opposite the first leaf;
at least one leaf of said tab sheet defining an external indicia recording surface thereon; and
the first leaf and the second leaf of said tab sheet adhesively secured together and extending substantially opposite the sheet gripping interstice of said clip so that said tab sheet is visible when said clip is removably secured to the edge of a sheet of material with the spine of said clip disposed immediately adjacent the edge of the sheet of material.

8. The paper clip with index tab assembly according to claim 7, wherein said clip comprises an ideal paper clip.

9. The paper clip with index tab assembly according to claim 7, wherein each said clamping member comprises a first segment extending generally orthogonally from the spine and a second segment extending diagonally between the first segments, the second segments terminating in overlapping coils.

10. A paper clip with index tab assembly, comprising:
a clip having an elongated, linear spine and first and second clamping members extending to one side of the spine from opposite ends of the spine, the clamping members defining a sheet gripping interstice therebetween;
a tab sheet wrapped about the spine of said clip, and adhesively secured permanently thereto;
said tab sheet having a first leaf comprising a hollow, flattened tube having at least one translucent side, and a second leaf opposite the first leaf; and
the first leaf and the second leaf adhesively secured together and extending substantially opposite the sheet gripping interstice of said clip so that said tab sheet is visible when said clip is removably secured to the edge of a sheet of material with the spine of said clip disposed immediately adjacent the edge of the sheet of material.

11. The paper clip with index tab assembly according to claim 10, further including an indicia recording tag removably disposed within the hollow tube of said tab sheet and visible through the at least one translucent side thereof when installed therein.

12. The paper clip with index tab assembly according to claim 10, wherein said clip comprises a single wire bent to form the spine and the clamp members.

13. The paper clip with index tab according to claim 10, wherein said clip comprises an Ideal paper clip.
